(19) United States
(12) Patent Application Publication
(10) Pub. No.: US 2007/0014356 A1
(43) Pub. Date: Jan. 18, 2007

(54) Video coding method and apparatus for reducing mismatch between encoder and decoder

(75) Inventors: Woo-jin Han, Suwon-si (KR); Bae-keun Lee, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/487,980

(22) Filed: Jul. 18, 2006

Related U.S. Application Data
(60) Provisional application No. 60/699,859, filed on Jul. 18, 2005.
(60) Provisional application No. 60/700,330, filed on Jul. 19, 2005.

(30) Foreign Application Priority Data
Sep. 23, 2005 (KR) 10-2005-0088921

(51) Int. Cl. H04N 7/12; H04B 1/66

(52) U.S. Cl. 375/240.12; 375/240.29

(57) ABSTRACT

A method of reducing mismatch between an encoder and a decoder in a motion compensated temporal filtering process and a video coding method and apparatus using the same. The video coding method includes the steps of dividing input frames into one final low-pass frame and at least one high-pass frame through a motion compensated temporal filtering, coding the final low-pass frame and then decoding the coded final low-pass frame, re-estimating the high-pass frame by using the decoded final low-pass frame, and coding the re-estimation high-pass frame.

### CROSS-REFERENCE TO RELATED APPLICATIONS

This application claims priority from Korean Patent Application No. 10-2005-0088921 filed on Sep. 23, 2005, and U.S. Provisional Patent Application Nos. 60/699,859 and 60/700,330 filed on Jul. 18, 2005 and Jul. 19, 2005, respectively, the whole disclosures of which are hereby incorporated herein by reference.

### BACKGROUND OF THE INVENTION

1. Field of the invention

Apparatuses and methods consistent with the present invention relate to a video coding technology, and more particularly to reducing mismatch between an encoder and a decoder in a motion compensated temporal filtering (MCTF) process.

2. Description of the Prior Art

Recently, with the advancements in information and communication technologies including the Internet, widespread use of multimedia communications is rapidly increasing along with text and voice communications. Since the existing text-based communication systems are insufficient to meet diverse needs of consumers, multimedia services that can deliver various types of information including texts, images, music, and others, are increasing. These multimedia services typically require a storage medium having a large capacity to store a massive amount of multimedia data. In addition, a wide bandwidth is also required to transmit multimedia data. For this reason, a compression-coding scheme must be implemented when transmitting multimedia data that includes texts, images and audio data.

Generally, data-compression refers to a process of removing redundant elements from data. That is, data can be compressed by removing spatial redundant elements (e.g., repetition of the same color or object in an image), temporal redundant elements (e.g., little or no variation between adjacent frames in moving picture frames or repetition of the same audio sound), and perceptual redundant elements (e.g., high frequencies beyond the noticeable range of human visual and perceptual capabilities) from the data. In general, the temporal redundant elements are removed by a motion compensated temporal filtering technique and the spatial redundant elements are removed by a spatial transform technique.

After the redundant elements have been removed, a transmission medium is required to transmit the multimedia data. Here, transmission mediums may have different transmission rates depending on the type of transmission medium. Currently, various types of transmission mediums having different transmission rates, such as a high-speed communication network capable of transmitting data with a transmission rate of several tens of Mbit/sec or a mobile communication network capable of transmitting data with a transmission rate of 384 kbit/sec, are used for transmitting multimedia data. In this circumstance, a scalable video coding scheme is more suitable for multimedia environments since it supports various transmission mediums having different transmission rates while allowing the multimedia data to be transmitted with a transmission rate appropriate for the transmission environment.

The scalable video coding scheme refers to a coding scheme capable of adjusting the resolution, frame rate and SNR (signal-to-noise ratio) of a video signal by partially truncating a compressed bit stream according to the variable conditions of a transmission environment, such as a transmission bit rate, a transmission error rate or system resources.

An MCTF technique has been widely used in the scalable video coding scheme for supporting temporal scalability, such as H.264 SE (scalable extension). In particular, a 5/3 MCTF technique using both left and right adjacent frames compresses data with high efficiency and can be applied to both temporal scalability and SNR scalability, such that the 5/3 MCTF technique has been adopted in the standard draft for H.264 SE, which is being prepared by the Moving Picture Experts Group (MPEG).

FIG. 1 is view illustrating a 5/3 MCTF structure for sequentially performing a prediction step and an update step with respect to one GOP (group of pictures).

As shown in FIG. 1, the prediction step and the update step are sequentially repeated in the MCTF structure according to the order of temporal levels. Here, a frame obtained through the prediction step is referred to as a high-pass frame (H) and a frame obtained through the update step is referred to as a low-pass frame (L). The prediction step and the update step may be repeated until one final low-pass frame (L) has been obtained.

FIG. 2 is a view illustrating the prediction step and the update step in detail. In FIG. 2, subscripts (t and t+1) represent temporal levels and superscripts (2, 1, 0, −1, and −2) represent the temporal orders, respectively. In addition, constants (a and b) represent the weight ratio of each frame in the prediction step or the update step.

In the prediction step, a high-pass frame (Hₜ₊₁⁰) is obtained based on the difference between a current frame (Lₜ⁰) and a prediction frame predicted from left and right adjacent reference frames (Lₜ⁻¹ and Lₜ¹). In the update step, the left and right adjacent reference frames (Lₜ⁻¹ and Lₜ¹), which have been used in the previous prediction step, are transformed by using the high-pass frame (Hₜ₊₁⁰) obtained in the prediction step. The update step is carried out in order to remove the high-pass element, that is, the high-pass frame (Hₜ₊₁⁰) from the reference frame, thus the update step is similar to the low-pass filtering process. Since transformed left and right adjacent reference frames (Lₜ₊₁⁻¹ and Lₜ₊₁¹) have no high-pass elements, the coding performance can be improved.

According to the MCTF technique, frames of the GOP are sequentially arranged corresponding to the temporal levels thereof, one H frame (high-pass frame) is obtained by performing the prediction step per each temporal level, and two reference frames used in the prediction step are transformed by using the H frame (update step). If the above process is performed with respect to N frames located in one temporal level, N/2 H frames and N/2 L frames can be obtained. Therefore, if this process is repeated until one L frame remains, M−1 H frames and one L frame may result on the assumption that the GOP has M frames. Thereafter, the remaining frames are quantized and the MCTF process ends.

In detail, according to the prediction step, optimum blocks are obtained by performing motion estimation with respect to the left and right adjacent frames as shown in FIG. 2, and an optimum prediction block is obtained by using the optimum blocks. In addition, blocks included in the H frame can be obtained by calculating the difference between the optimum prediction block and the original block. Since FIG. 2 represents the bi-directional prediction, constant α is −½. However, if a single directional prediction is performed using the left or right reference frame, constant a may be −1.

The update step may serve to remove the high-pass elements of the left and right reference frames by using the differential image obtained through the prediction step, that is, the H frame value. As shown in FIG. 2, the left and right adjacent reference frames (Lₜ⁻¹ and Lₜ¹) are transformed to reference frames (Lₜ₊₁⁻¹ and Lₜ₊₁¹) having no high-pass elements through the update step.

The above MCTF structure is different from the conventional data-compression scheme, such as MPEG-4 or H.264, in that the MCTF structure includes a video codec having an open-loop structure and uses the update step in order to reduce the drift error. The open-loop structure uses un-quantized left and right reference frames in order to obtain the differential image (high-pass frame). In contrast, the conventional video codec mainly uses a closed-loop structure, which previously codes and quantizes the reference frames and then decodes the reference frames.

Such an MCTF open-loop codec is better than the closed-loop codec if SNR scalability is applied, that is, when the quality of the reference frame used in a decoder side is poorer than that of an encoder side. On the other hand, the open-loop structure has an error drift problem, which results from the mismatch of reference frames between the encoder and the decoder. In order to solve the above problem, the MCTF technique removes the high-pass elements of the differential image from the L frame of the next temporal level through the update step, thereby improving the data-compression efficiency and reducing the amount of the error drift derived from the open-loop structure. However, although the amount of error drift may decrease through the update step, the mismatch between the encoder and the decoder still remains in the open-loop structure, such that the performance is inevitably degraded.

There are two kinds of mismatches between the encoder and the decoder in the MCTF codec. The first is the mismatch in the prediction step. Referring to the prediction step shown in FIG. 2, the left and right reference frames are used to obtain the H frame. However, since the left and right reference frames are not quantized, the H frame derived from the left and right reference frames may not be an optimum signal in the decoder side. However, since the left and right reference frames must be transformed through the update step and transformed into the H frames in the next temporal level so as to be quantized, it is difficult to previously quantize the reference frames if the MCTF structure has an open-loop structure, rather than a closed-loop structure.

The second kind of mismatch is the mismatch in the update step. Referring to the update step shown in FIG. 2, the high-pass frame (Hₜ₊₁⁰) is used for changing the left and right adjacent reference frames (Lₜ⁻¹ and Lₜ¹). However, since the high-pass frame has not been yet quantized, the mismatch may occur between the encoder and the decoder.

### SUMMARY OF THE INVENTION

Accordingly, an aspect of the present invention is to provide an apparatus and method capable of improving the video compression efficiency by reducing the drift error between an encoder and a decoder in an MCTF video codec.

Another aspect of the present invention is to provide an apparatus and method capable of effectively re-estimating a high-pass frame in an MCTF video codec.

The present invention is not limited to the above aspects, and those skilled in the art will appreciate other aspects of the present invention from the following description.

According to an aspect of the present invention, there is provided a video encoding method including the steps of (a) dividing input frames into one final low-pass frame and at least one high-pass frame by a motion compensated temporal filtering, (b) coding the final low-pass frame and then decoding the coded final low-pass frame, (c) re-estimating the high-pass frame by using the decoded final low-pass frame, and (d) coding the re-estimation high-pass frame.

According to another aspect of the present invention, there is provided a video decoding method including the steps of (a) restoring a final low-pass frame and at least one high-pass frame from texture data included in an input stream, and (b) restoring low-pass frames located in a lowest time level from among the final low-pass frame and at least one high-pass frame, in which step (b) includes the substeps of (b1) inversely predicting the high-pass frame by using a first low-pass frame located in a predetermined temporal level as a reference frame, thereby restoring a second low-pass frame corresponding to the high-pass frame, and (b2) inversely updating the first low-pass frame using the restored high-pass frame.

According to still another aspect of the present invention, there is provided a video encoder including a means for dividing input frames into one final low-pass frame and at least one high-pass frame by a motion compensated temporal filtering, a means for coding the final low-pass frame and then decoding the coded final low-pass frame, a means for re-estimating the high-pass frame by using the decoded final low-pass frame, and a means for coding the re-estimation high-pass frame.

According to still yet another aspect of the present invention, there is provided a video decoder including a first means for restoring a final low-pass frame and at least one high-pass frame from texture data included in an input stream, and a second means for restoring low-pass frames located in a lowest time level from among the final low-pass frame and at least one high-pass frame, in which the second means includes a means for inversely predicting the high-pass frame by using a first low-pass frame located in a predetermined temporal level as a reference frame, thereby restoring a second low-pass frame corresponding to the high-pass frame, and a means for inversely updating the first low-pass frame using the restored high-pass frame.

### BRIEF DESCRIPTION OF THE DRAWINGS

The above and other aspects of the present invention will be more apparent from the following detailed description taken in conjunction with the accompanying drawings, in which:

FIG. 1 is a view illustrating a conventional MCTF process;

FIG. 2 is a view illustrating in detail a prediction step and an update step shown in FIG. 1;

FIG. 3 is a view illustrating an MCTF process according to a first exemplary embodiment of the present invention;

FIG. 4 is a view illustrating a re-estimation process according to the first exemplary embodiment of the present invention;

FIG. 5 is a view illustrating an inverse MCTF process according to the first exemplary embodiment of the present invention;

FIG. 6 is a view illustrating a re-estimation process according to a second exemplary embodiment of the present invention;

FIG. 7 is a view illustrating an inverse MCTF process according to the second exemplary embodiment of the present invention;

FIG. 8 is a view illustrating an inverse MCTF process according to a third exemplary embodiment of the present invention;

FIG. 9 is a block view illustrating the structure of a video encoder according to one exemplary embodiment of the present invention;

FIG. 10 is a block view illustrating the structure of a video decoder according to one exemplary embodiment of the present invention; and

FIG. 11 is a block view illustrating the structure of a system for realizing the operation of the video encoder shown in FIG. 9 or the video decoder shown in FIG. 10.

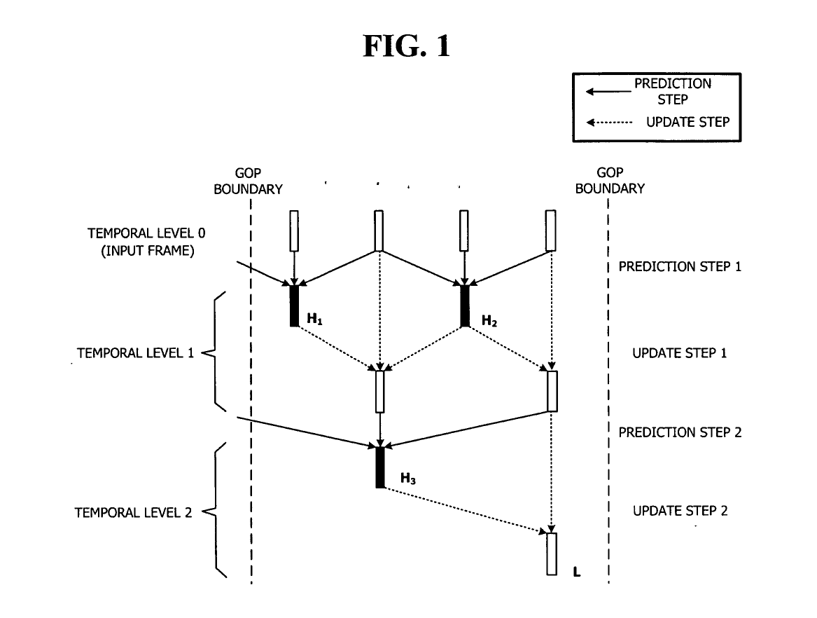

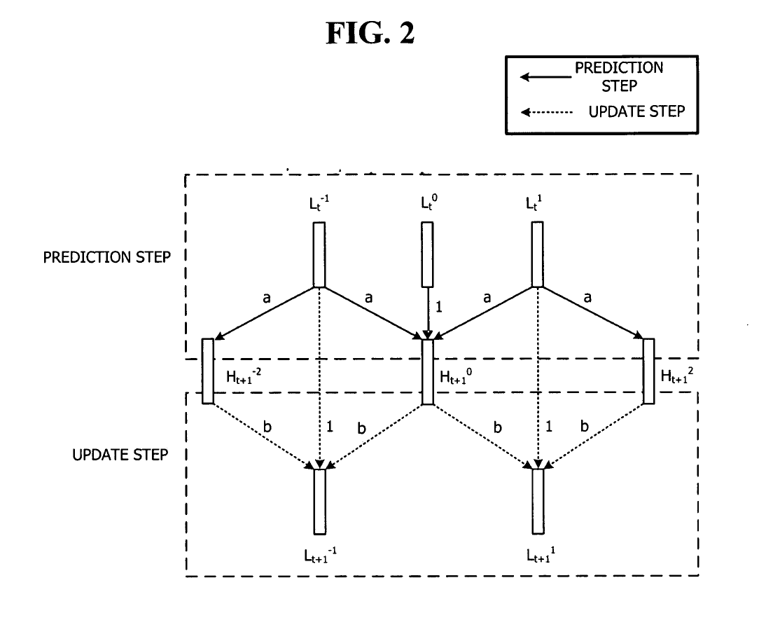

### DETAILED DESCRIPTION OF EXEMPLARY EMBODIMENTS

Hereinafter, exemplary embodiments of the present invention will be described with reference to the accompanying drawings. The matters defined in the description such as a detailed construction and elements are provided to assist in a comprehensive understanding of the invention. Thus, it should be apparent that the present invention can be carried out without those defined matter. In the following description of the present invention and in the drawings, the same reference numerals are used for the same elements. Also, a detailed description of known functions and configurations incorporated herein will be omitted.

The present invention provides a method of reducing the mismatch in the prediction step by re-estimating the H frame during the coding/decoding processes after the MCTF process (hereinafter, this process will be referred to as a “frame re-estimation process”). In addition, the present invention will be described with reference to exemplary embodiments, in which each embodiment may include MCTF, re-estimation, and inverse MCTF processes. The MCTF and re-estimation processes are performed at the side of the video encoder and the inverse MCTF process is performed at the side of the video decoder.

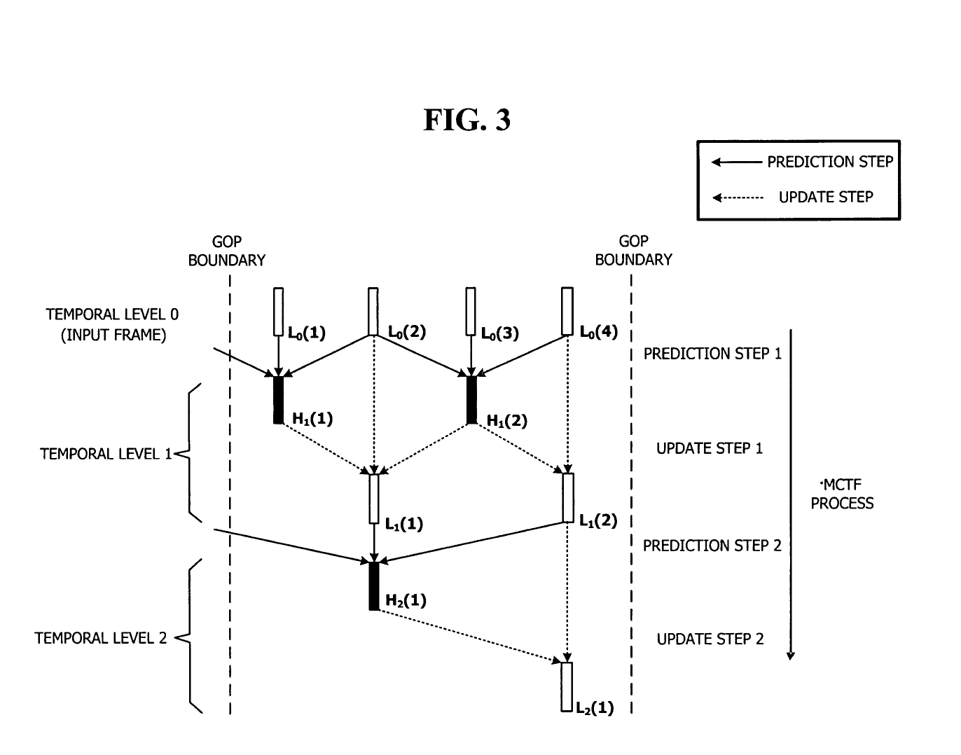

FIG. 3 is a view illustrating a 5/3 MCTF process according to a first exemplary embodiment of the present invention. The first exemplary embodiment of the present invention may implement the conventional MCTF scheme. In general, the MCTF process is performed through a lifting scheme including a prediction step and an update step. According to the lifting scheme, input frames are divided into low-pass frames to be subjected to low-pass filtering (hereinafter, referred to as L-position frames) and high-pass frames to be subjected to high-pass filtering (hereinafter, referred to as H-position frames). The prediction step is applied to the H-position frames by using the adjacent frames, thereby obtaining the H frame. In addition, the update step is applied to the L-position frames by using the H frame obtained through the prediction step, thereby obtaining the L frame.

In the following description, subscripts represent temporal levels, characters positioned in parentheses denote indexes allocated to the H frame and L frame in a specific temporal level. For instance, referring to FIG. 3, four L frames L₀(1), L₀(2), L₀(3) and L₀(4) may exist in the temporal level 0, and two H frames H₁(1) and H₁(2) and two L frames L₁(1) and L₁(2) may exist in the next temporal level 1. In view of the temporal order of the frames, the four L frames L₀(1), L₀(2), L₀(3) and L₀(4) correspond to the H and L frames H₁(1), L₁(1), H₁(2) and L₁(2), respectively.

The prediction step and the update step can be expressed as Equation 1.
Hₜ₊₁(k)=Lₜ(2k−1)−P
Lₜ₊₁(k)=Lₜ(2k)+U Equation 1

In Equation 1, Lₜ( ) denotes an L frame obtained in the temporal level t. Here, L₀( ) (t=0) stands for the original input frame. Hₜ₊₁( ) denotes an H frame obtained in the temporal level t+1, Lₜ₊₁( ) denotes an L frame obtained in the temporal level t+1, and the constant in the parenthesis denotes an index. If a Haar filter is used in the MCTF process, P and U in Equation 1 can be expressed as Equation 2.

$$P = {L}_{t} ( 2 k ) \\ U = \frac{1}{2} {H}_{t + 1} ( k ) \qquad Equation 2$$

In addition, if a 5/3 filter capable of utilizing both left and right reference frames is used in the MCTF process, P and U in Equation 1 can be represented as Equation 3.

$$P = \frac{1}{2} ( {L}_{t} ( 2 k - 2 ) + {L}_{t} ( 2 k ) ) \\ U = \frac{1}{4} ( {H}_{t + 1} ( k ) + {H}_{t + 1} ( k + 1 ) ) \qquad Equation 3$$

The prediction step and the update step may be repeated until one L frame finally remains. As a result, in the case shown in FIG. 3, one L frame L₂(1) and three H frames H₁(1), H₁(2) and H₂(1) may be obtained.

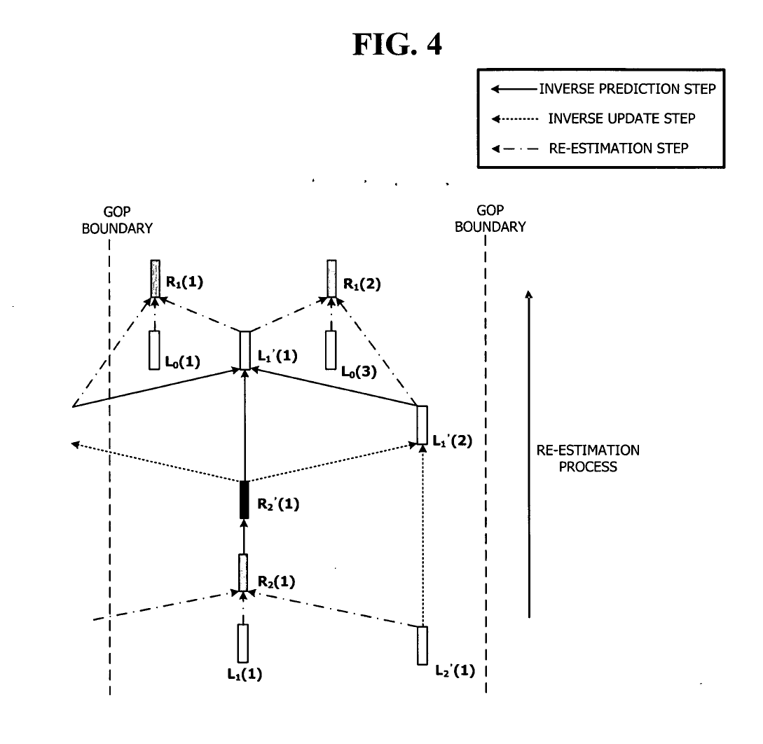

FIG. 4 is a view illustrating a re-estimation process according to the first exemplary embodiment of the present invention.

First, the final L frame L₂(1) is coded and then decoded. The coding process may include a transform process and a quantization process, and the decoding process may include a de-quantization process and an inverse transform process. In the following description, the coding and decoding processes will be referred to as a “restoration process”. A finally restored L frame is represented as L₂′(1). In the following description, the frame denoted with a prime mark “′” refers to the frame which has undergone the restoration process. In order to re-estimate the frame H₂(1) by using the frame L₂′(1), the frame L₁(1) obtained through the MCTF process is necessary. It is also possible to use the original L₀(2) instead of the frame L₁(1).

Then, the high-pass frame H₂(1) for the frame L₁(1) is re-estimated by using the reference frame L₂′(1). As shown in FIG. 4, the reference frame may further include a frame of the previous GOP. In addition, a previously restored frame of the previous GOP can be used in the re-estimation process for the current GOP. If the index in the parenthesis of the H frame or the L frame has a negative magnitude, it refers to the frame of the previous GOP.

The re-estimation frame is denoted with a reference character R₂(1). A calculation process for the re-estimation may be the same as the calculation process for the prediction step in the MCTF process, except that the reference frame used for the re-estimation is restored. Thus, the general re-estimation Rₜ₊₁(k) including the re-estimation frame R₂(1) can be expressed as Equation 4.

$${R}_{t + 1} ( k ) = {L}_{t} ( 2 k - 1 ) - {P}^{′} \\ wherein , \\ {P}^{′} = \frac{1}{2} ( {L}_{t}^{′} ( 2 k - 2 ) + {L}_{t}^{′} ( 2 k ) ) \\ when the 5 \text{/} 3 filter is used . \qquad Equation 4$$

Thereafter, the re-estimation frame R₂(1) is coded and then decoded, thereby obtaining the frame R₂′(1). In addition, the frame L₂′(1) is inversely updated by using the frame R₂′(1). As a result, a frame L₁′(2) is obtained. The inverse update step is performed in reverse order to the order of the update step in the MCTF process. The inverse update step can be expressed as Equation 5 by transforming Equation 1.

$${L}_{t} ( 2 k ) = {L}_{t + 1} ( k ) - {U}^{′} \\ wherein , \\ {U}^{′} = \frac{1}{4} ( {R}_{t + 1}^{′} ( k ) + {R}_{t + 1}^{′} ( k ) + 1 ) \\ when the 5 \text{/} 3 filter is used . \qquad Equation 5$$

Then, the frame R₂′(1) is inversely predicted by using reference frames L₁′(2) and L₁′(0), in which the L₁′(0) (not shown) is the frame of the previous GOP, thereby obtaining the frame L₁′(1). Such an inverse prediction step can be expressed as Equation 6.

$${L}_{t} ( 2 k - 1 ) = {R}_{t + 1}^{′} ( k ) - {P}^{′} \\ wherein , \\ {P}^{′} = \frac{1}{2} ( {L}_{t}^{′} ( 2 k - 2 ) + {L}_{t}^{′} ( 2 k ) ) \\ when the 5 \text{/} 3 filter is used \qquad Equation 6$$

Thus, the frame R₁(2) can be obtained by re-estimating the high-pass frame for the frame L₀(3) by using the obtained frames L₁′(1) and L₁′(2). In addition, the frame R₁(1) can be obtained by re-estimating the high-pass frame for the frame L₀(1) by using the frames L₁′(1) and L₁′(0), in which the L₁′(0) (not shown) is the frame of the previous GOP.

Although FIG. 4 illustrates the GOP including four frames, if the GOP includes more than four frames, the above steps must be repeated corresponding to the number of frames.

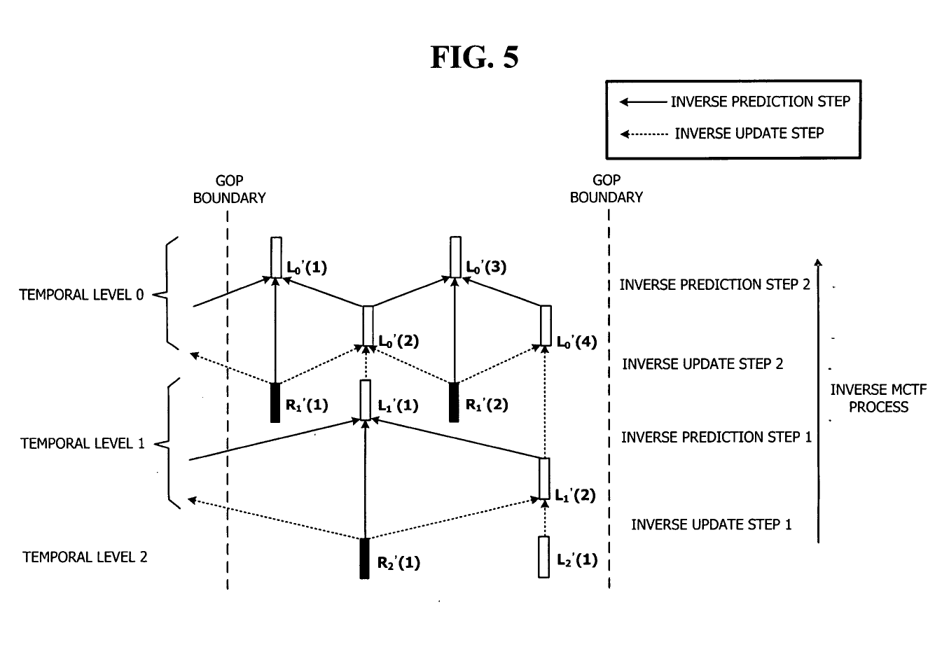

A video encoder quantizes the re-estimate frames R₁(1), R₁(2) and R₂(1) and the final low-pass frame L₂(1) and transmits them to a video decoder. Accordingly, the video decoder de-quantizes the re-estimate frames R₁(1), R₁(2) and R₂(1) and the final low-pass frame L₂(1), and then performs the inverse MCTF process, thereby restoring low-pass frames in the temporal level 0. Hereinafter, the inverse MCTF process performed at the side of the video decoder will be described with reference to FIG. 5.

The inverse MCTF process according to the first exemplary embodiment of the present invention is substantially identical to the conventional inverse MCTF process, except that the re-estimation frames are used instead of the high-pass frames.

First, the final low-pass frame L₂′(1) is inversely updated by using the restored re-estimation frame R₂′(1) (inverse update step 1). As a result, the frame L₁′(2) is obtained. Then, the re-estimation frame R₂′(1) is inversely predicted by using the reference frames L₁′(2) and L₁′(0), in which the reference frame L₁′(2) is obtained through the inverse update step and the reference frame L₁′(0) (not shown) is the frame of the previous GOP, thereby restoring the low-pass frame L₁′(1) (inverse prediction step 1).

In the same manner, inverse update step 2 and inverse prediction step 2 are performed, thereby restoring four low-pass frames L₀′(1), L₀′(2), L₀′(3) and L₀′(4) in the temporal level 0.

According to the first exemplary embodiment of the present invention, the frame re-estimation scheme is employed in order to apply the closed-loop structure to the MCTF technique including the prediction step and the update step. In this manner, the open-loop type MCTF can be changed into the closed-loop type MCTF, so that the mismatch between the encoder and the decoder can be reduced.

In addition, according to the first exemplary embodiment of the present invention, the re-estimation process in the encoder and the inverse MCTF process in the decoder may sequentially perform the inverse update step and the inverse prediction step. However, the mismatch between the encoder and the decoder may still exist because the update step designed for the open-loop codec is used together with the closed-loop prediction step.

Referring to the re-estimation process shown in FIG. 4, the re-estimation frame R₂(1) is obtained by using the reference frame L₂′(1). However, the reference frame used for inversely predicting the frame L₁′(1) from the re-estimation frame R₂′(1) is not the frame L₂′(1), but the frame L₁′(2) which is inversely updated from the frame L₂′(1). The same situation is represented in the inverse MCTF process shown in FIG. 5. That is, referring to FIG. 5, the frame L₁′(2), which is inversely updated from the frame L₂′(1), is used for inversely predicting the frame L₁′(1) from the re-estimation frame R₂′(1). Consequently, the reference frame L₂′(1) is used for predicting the re-estimation frame R₂(1) from the low-pass frame L₁(1) and the reference frame L₁′(2) is used for restoring the low-pass frame L₁′(1) from the re-estimation frame R₂′(1).

Therefore, although the MCTF scheme according to the first exemplary embodiment of the present invention can reduce the drift error because it has the closed-loop structure, since the update step is performed after the prediction step in the MCTF process and the prediction step is performed after the update step in the inverse MCTF process, the mismatch may still exist between the encoder and the decoder.

A second exemplary embodiment of the present invention provides a method of solving the mismatch problem occurring in the first exemplary embodiment of the present invention.

First, the conventional MCTF process shown in FIG. 3 is performed, thereby obtaining at least one high-pass frame H₁(1), H₁(2) or H₂(1) and a final low-pass frame L₂(1). In addition, the final low-pass frame L₂(1) is coded and then decoded.

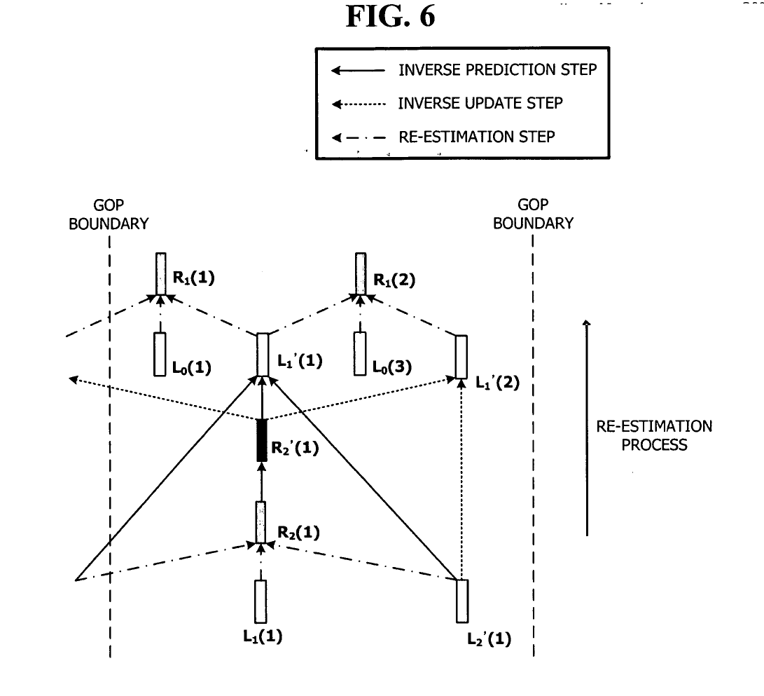

Thereafter, as shown in FIG. 6, the re-estimation process is performed by using the decoded final low-pass frame L₂′(1).

That is, the high-pass frame H₂(1) for the low-pass frame L₁(1) is re-estimated by using the reference frame L₂′(1). As illustrated in FIG. 6, the reference frame may further include a frame of the previous GOP. In addition, a previously restored frame of the previous GOP can be used in the re-estimation process for the current GOP. The re-estimation frame is denoted with a reference character R₂(1). Such a re-estimation step may be performed while satisfying Equation 4.

Thereafter, the re-estimation frame R₂(1) is coded and then decoded, thereby obtaining the frame R₂′(1). In addition, the re-estimation frame R₂′(1) is inversely estimated by using the reference frame L₂′(1), thereby obtaining the low-pass frame L₁′(1). Such an inverse prediction step is expressed in Equation 6. Then, the frame L₂′(1) is inversely updated by using the frame R₂′(1), thereby obtaining the low-pass frame L₁′(2). Such an inverse update step is expressed in Equation 5.

Herein, the step for obtaining the low-pass frame L₁′(1) is performed separately from the step for obtaining the low-pass frame L₁′(2). That is, the result of one step may not be utilized in the other step. Accordingly, it is also possible to reverse the sequence of the above two steps. To this end, the final low-pass frame L₂′(1) must be stored in a buffer before it is updated.

The second exemplary embodiment of the present invention is different from the first exemplary embodiment of the present invention in that the reference frame, which is used for obtaining the low-pass frame by inversely predicting the re-estimation frame, has not been subject to the inverse update step.

Thus, the frame R₁(2) can be obtained by re-estimating the high-pass frame for the frame L₀(3) by using the obtained frames L₁′(1) and L₁′(2). In addition, the frame R₁(1) can be obtained by re-estimating the high-pass frame for the frame L₀(1) by using the frames L₁′(1) and L₁′(0), in which the L₁′(0) (not shown) is the frame of the previous GOP. If the GOP includes many frames, the above steps must be repeated corresponding to the number of frames.

The inverse MCTF process, which corresponds to the MCTF process and the re-estimation process performed at the video encoder side, is carried out at the video decoder side. Similarly to the re-estimation process, the inverse MCTF process according to the second exemplary embodiment of the present invention uses the reference frame, which is not inversely updated, in order to create the low-pass frame by inversely predicting the re-estimation frame.

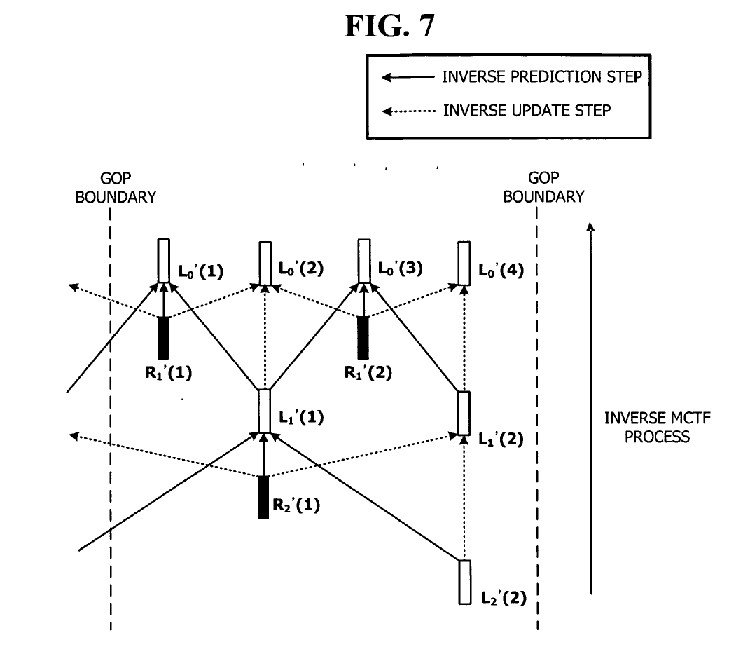

In detail, referring to FIG. 7, the re-estimation frame R₂′(1) is inversely predicted by using the reference frames L₂′(2) and L₂′(0), in which the reference frame L₂′(2) is the final low-pass frame and the reference frame L₂′(0) (not shown) is the frame of the previous GOP, thereby restoring the low-pass frame L₁′(1) (inverse predication step 1). Thereafter, the final low-pass frame L₂′(2) is inversely updated by using the re-estimation frame R₂′(1) (inverse update step 1). As a result, the low-pass frame L₁′(2) is obtained.

Here, the step for obtaining the low-pass frame L₁′(1) is performed separately from the step for obtaining the low-pass frame L₁′(2). That is, the result of one step may not be utilized in the other step. Accordingly, it is also possible to reverse the sequence of the above two steps.

In the same manner, inverse prediction step 2 and inverse update step 2 are performed, thereby restoring four low-pass frames L₀′(1) L₀′(2) L₀′(3) and L₀′(4) in the temporal level 0.

Although the update step is useful in a structure supporting the temporal scalability, the number of operations may significantly increase because it requires an additional motion compensation process. Different from the conventional MCTF process, the first and second exemplary embodiments of the present invention employ the closed-loop prediction, so that all high-pass frames and high-pass residuals can be re-estimated without causing the mismatch regardless of the update step. Accordingly, the performance may not be degraded even if the inverse update steps for the low-pass frames located in the temporal levels, in which the high-pass frames exist, are omitted.

Therefore, according to a third exemplary embodiment of the present invention, the MCTF process performed at the encoder side may be achieved by performing the update step with respect to all low-pass frames similarly to the conventional MCTF process. However, the re-estimation process and the inverse MCTF process at the decoder side are performed while omitting the update steps for the low-pass frames located in the temporal levels, in which the high-pass frames exist, thereby significantly reducing the number of operations.

Conventionally, the inverse update steps must be performed corresponding to the number of high-pass frames located in one temporal level. However, according to the third exemplary embodiment of the present invention, it is sufficient to just perform the inverse update step with respect to only one low-pass frame per one temporal level. If this feature is applied to the second exemplary embodiment of the present invention, the mismatch caused by the closed-loop prediction may not occur.

For instance, according to the conventional MCTF process, the inverse update steps must be performed with respect to all high-pass frames, that is, when the GOP has N frames, the inverse update steps may be performed N−1 times. In contrast, according to the third exemplary embodiment of the present invention, it is sufficient to just perform the inverse update steps log₂ N times. That is, N-degree operations can be replaced with log₂ N-degree operations, so the operations are more simplified. This advantage is derived from the frame re-estimation technique according to the present invention.

In general, the reduced number (C) of operations for inverse update steps according to the third exemplary embodiment of the present invention can be expressed as Equation 7.
C=(N−1)−log₂ N Equation 7

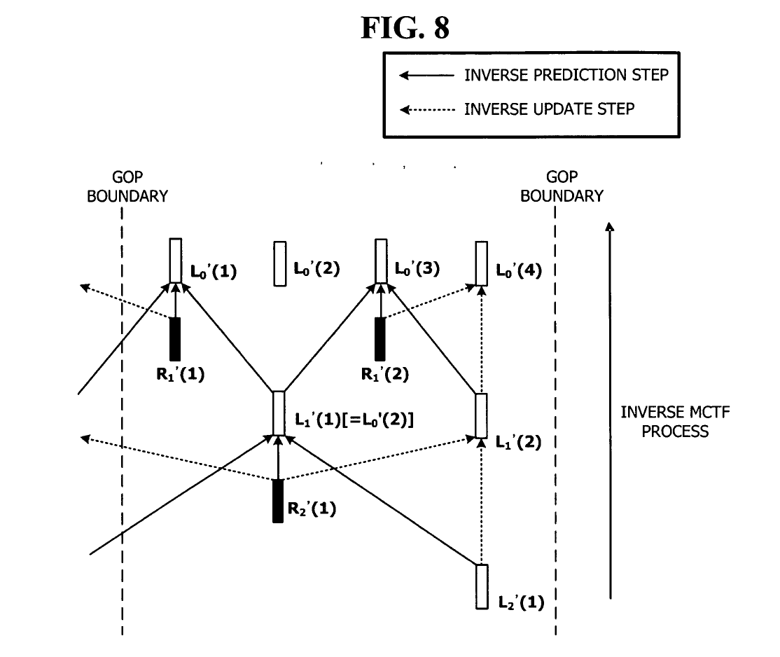

FIG. 8 is a view illustrating the inverse MCTF process according to the third exemplary embodiment of the present invention.

When comparing FIG. 8 with FIG. 7, the low-pass frames L₂′(1) and L₁′(2) located in the temporal level having no high-pass frames R₁′(1), R₂′(1) and R₁′(2) are inversely updated. However, the low-pass frames located in other temporal levels are not inversely updated. Accordingly, the low-pass frame L₁′(1) becomes the low-pass frame L₀′(2) at the temporal level 0 without being inversely updated. In the case of FIG. 8, the number of frames is four (N=4), so the reduced number (C) of operations is one. However, if the number of frames is 32 (N=32), the reduced number (C) of operations is 26.

The inverse update scheme for the frame located in the latest temporal position of the GOP performed during the inverse MCTF process can be applied to the re-estimation process as shown in FIG. 6.

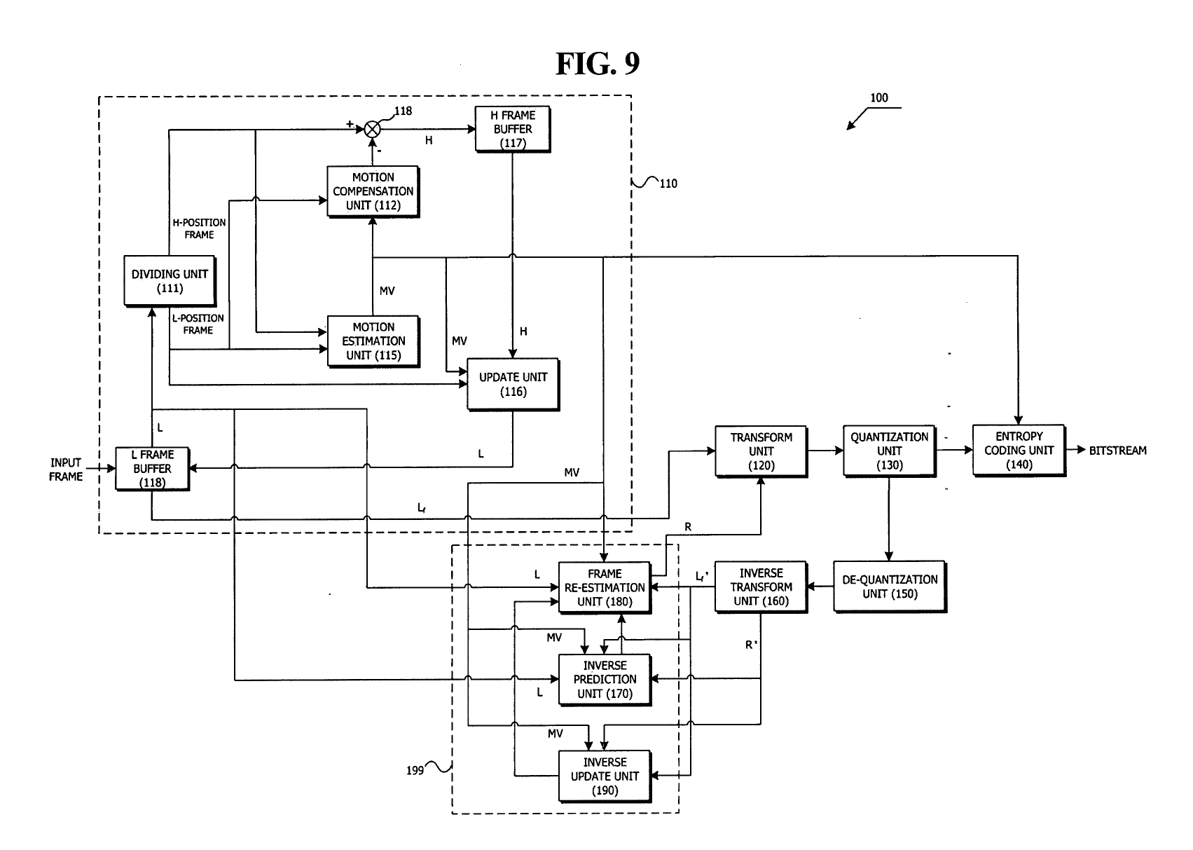

FIG. 9 is a block view illustrating the structure of a video encoder 100 according to one exemplary embodiment of the present invention.

The video encoder 100 includes an MCTF unit 110, a re-estimation unit 199, a transform unit 120, a quantization unit 130, a de-quantization (inverse quantization) unit 150, an inverse transform unit 160, and an entropy coding unit 140.

First, description will be made in relation to the operation of the MCTF unit 110. Input frames are inputted into an L frame buffer 117. Here, the input frames are a part of the L frames (low-pass frames). The L frames stored in the L frame buffer 117 are provided to a dividing unit 111.

Upon receiving the L frames, the dividing unit 111 divides the L frames into L-position frames (low-pass frames) and H-position frames (high-pass frames). In general, the high-pass frames are located in odd positions (2i-1) and the low-pass frames are located in even positions (2i). Here, “i” is an integer index representing the frame number. The H-position frames are transformed into H frames through the prediction step, and the L-position frames are transformed into low-pass frames adaptable for the next temporal level through the update step.

The H-position frames are inputted into a motion estimation unit 115 and a difference unit 118.

The motion estimation unit 115 performs motion estimation with respect to the H-position frame (hereinafter, referred to as a current frame) based on peripheral frames (frames located in different temporal position at the same temporal level), thereby obtaining a motion vector (MV). The peripheral frames are referred to as “reference frames”.

In general, a block matching algorithm is extensively used for the motion estimation. That is, a predetermined block is moved within a specific search area of the reference frame in a pixel unit or a sub-pixel unit (e.g., ¼ pixel) and the displacement of the block corresponding to the lowest error is estimated as a motion vector. Although a fixing vector can be used for the motion estimation, HVSBM (hierarchical variable size block matching) is preferably used for the motion estimation.

The motion vector (MV) obtained by the motion estimation unit 115 is transferred to a motion compensation unit 112. Then, the motion compensation unit 112 performs the motion compensation with respect to the reference frames by using the motion vector (MV), thereby obtaining the prediction frame for the current frame. The prediction frame is expressed as “P” shown in Equation 1.

The difference unit 118 calculates the difference between the current frame and the prediction frame so as to create the high-pass frames (H frames). The high-pass frames are temporarily stored in the H frame buffer 117.

In the meantime, the update unit 116 updates the L-position frames by using the obtained high-pass frames, thereby obtaining low-pass frames. In the case of the 5/3 MCTF process, a predetermined L-position frame may be updated by using two high-pass frames, which are temporally adjacent to the L-position frame. If a single reference frame is used (that is, in the case of the Haar MCTF), the update process may be performed in the single direction. The update process can be expressed as the second equation of Equation 1. The low-pass frames obtained by means of the update unit 116 are temporarily stored in the L frame buffer 118. The L frame buffer 118 transfers the low-pass frames to the dividing unit 111 so as to perform the prediction and update steps in the next temporal level.

Meanwhile, since the next temporal level may not exist in the case of the final low-pass frame (L_{f}), the final low-pass frame (L_{f}) is transferred to the transform unit 120.

The transform unit 120 performs spatial transform with respect to the final low-pass frame (L_{f}) and generates a transform coefficient. The spatial transform may include DCT (discrete cosine transform) or wavelet transform. In the case of the DCT, the transform coefficient is a DCT coefficient. In addition, in the case of the wavelet transform, the transform coefficient is a wavelet coefficient.

A quantization unit 130 is provided to quantize the transform coefficient. The term “quantization” means a procedure for representing the transform coefficient, which is expressed as a real number, in the form of a discrete value. For instance, the quantization unit 130 performs the quantization procedure by dividing the real-number transform coefficient through predetermined quantization steps and rounding off the result value to an integer value, which is called “scalar quantization”. The quantization steps are provided in a predetermined quantization table.

The quantization result obtained through the quantization procedure of the quantization unit 130, that is, the quantization coefficient of the low-pass frame L_{f} is sent to the entropy coding unit 140 and the de-quantization unit 150.

The de-quantization unit 150 de-quantizes the quantization coefficient of the low-pass frame L_{f.} The term “de-quantization” means a procedure for restoring a value matching with an index obtained through the quantization procedure by using the predetermined quantization table, which is used for the quantization procedure.

The inverse transform unit 160 receives the de-quantized result and performs an inverse transform with respect to the de-quantized result. Such an inverse transform process may proceed inversely to the transform process through the inverse DCT transform or the inverse wavelet transform. As a result, a final low-pass frame L_{f}′ is restored and the restored final low-pass frame L_{f}′ is sent to an inverse update unit 190.

Hereinafter, the operation of the re-estimation unit 199 will be described. The re-estimation unit 199 re-estimates the high-pass frames using the restored final low-pass frame L_{f}′. Examples of the re-estimation processes are shown in FIGS. 4 and 6, respectively. The re-estimation unit 199 includes the inverse update unit 190, a frame re-estimation unit 180 and an inverse prediction unit 170.

First, according to the second exemplary embodiment of the present invention, the frame re-estimation unit 180 re-estimates the high-pass frames located in the temporal level identical to that of the restored final low-pass frame L_{f}′ by using the restored final low-pass frame L_{f}′ as a reference frame. The re-estimation step is expressed in Equation 4.

The re-estimation high-pass frame R can be decoded through the transform unit 120, the quantization unit 130, the de-quantization unit 150 and the inverse transform unit 160.

The inverse prediction unit 170 inversely predicts the decoded high-pass frame by using the restored final low-pass frame L_{f}′ as a reference frame, thereby restoring a low-pass frame corresponding to the decoded high-pass frame. The inverse prediction step is expressed in Equation 6. The restored low-pass frame can be sent back to the frame re-estimation unit 180. In the same manner, the inverse prediction unit 170 may perform the inverse prediction in the next temporal level (low-class temporal level) by using a predetermined reference frame.

The inverse update unit 190 inversely updates the restored final low-pass frame L_{f}′ by using the decoded high-pass frame. The inverse update step is expressed in Equation 5. In this manner, the inversely updated low-pass frame is sent back to the frame re-estimation unit 180. In the same way, the inverse update unit 190 may perform the inverse update process in the next temporal level (low-class temporal level) by using the decoded high-pass frame provided from the inverse transform unit 160.

Thus, the frame re-estimation unit 180 can again perform the re-estimation process in the next temporal level by using the low-pass frames provided from the inverse prediction unit 170 and the inverse update unit 190 and the predetermined low-pass frame stored in the L frame buffer.

In the meantime, the motion compensation is performed by using the motion vector (MV) calculated by the motion estimation unit 115 during the re-estimation step, the inverse prediction step and the inverse update step.

The above operation of the re-estimation unit 199 may be repeated until the re-estimation has been completed with respect to all high-pass frames.

Meanwhile, when comparing the first exemplary embodiment with the second exemplary embodiment with respect to the inverse prediction step, the only difference is that whether or not the low-pass frame used as the reference frame has been subjected to the inverse update step.

According to the third exemplary embodiment of the present invention, the inverse update unit 190 further performs a step of determining whether the inputted low-pass frame is located in a position having the high-pass frames. If the inputted low-pass frame is located in the position having the high-pass frames, the inverse update step for the corresponding low-pass frame may be omitted. Otherwise, the inverse update step is performed with respect to the corresponding low-pass frame

The high-pass frames R, which have been re-estimated in the frame re-estimation unit 180, are sequentially subject to the transform and quantization processes by means of the transform unit 120 and the quantization unit 130, respectively. However, the above processes may not be applied to the re-estimated frame, such as the frame R₂′, which has already been subjected to the above processes.

The entropy coding unit 140 receives the quantization coefficient of the final low-pass frame L_{f} obtained by the quantization unit 130 and the quantization coefficient of the re-estimation high-pass frames R and codes the quantization coefficients through a lossless coding scheme, thereby obtaining bit streams. Such a lossless coding scheme includes Huffman coding, arithmetic coding, variable length coding, etc.

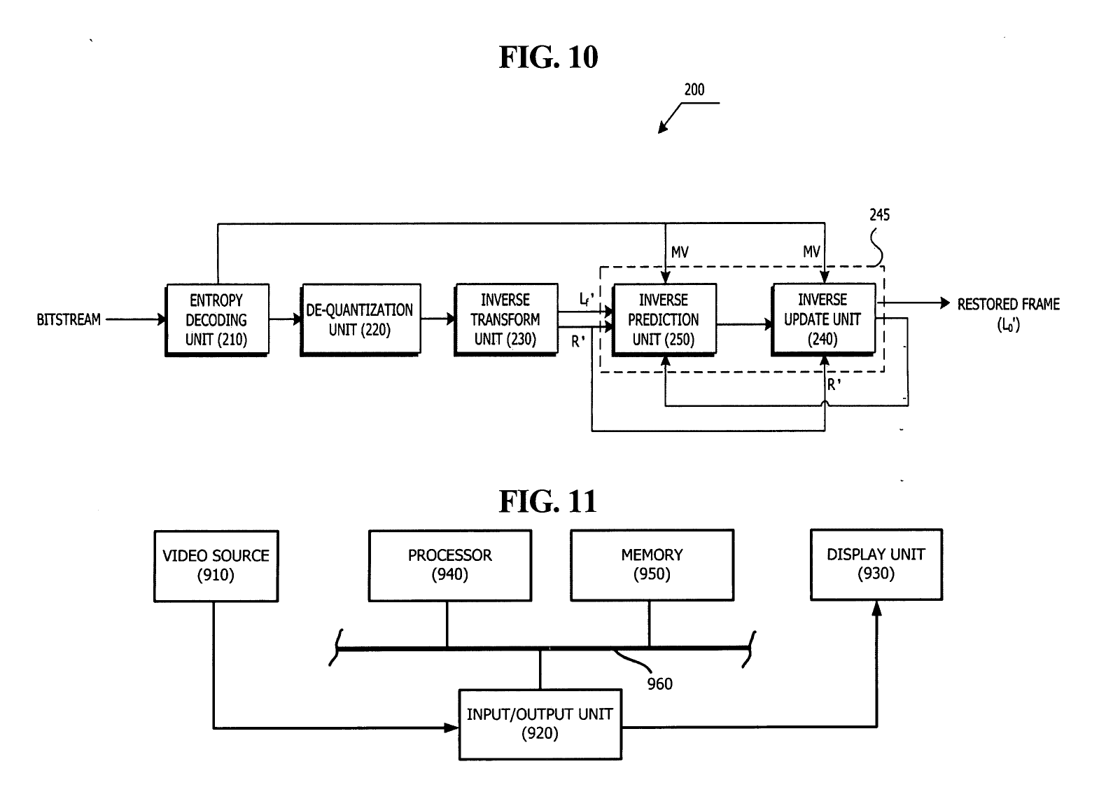

FIG. 10 is a block view illustrating the structure of a video decoder 200 according to one exemplary embodiment of the present invention.

An entropy decoding unit 210 performs a lossless decoding process, thereby extracting texture data and motion vector data for each frame from the bit streams inputted thereto. The extracted texture data are sent to a de-quantization unit 220 and the extracted motion vector data are sent to an inverse update unit 240 and an inverse prediction unit 250.

The de-quantization unit 220 is provided to de-quantize the texture data outputted from the entropy decoding unit 210. The “de-quantization” means a procedure for restoring a value matching with an index obtained through the quantization procedure by using the quantization table, which is used for the quantization procedure.

An inverse transform unit 230 performs inverse transform with respect to the de-quantized result. Such an inverse transform process may proceed inversely to the transform process performed in the transform unit 120 of the video encoder 100. Here, the inverse transform includes inverse DCT transform or inverse wavelet transform. As a result, the final low-pass frame and the re-estimation high-pass frame are restored.

The restored final low-pass frame L_{f}′ is sent to an inverse prediction unit 250 and the restored re-estimation high-pass frame R′ is sent to both the inverse update unit 240 and the inverse prediction unit 250. An inverse MCTF unit 245 may repeat the inverse prediction step and the inverse update step by using the inverse prediction unit 250 and the inverse update unit 240, thereby obtaining a finally restored low-pass frame L₀′. Such a repetition of the prediction and update steps may continue until the frame located in the temporal level 0, that is, the input frame of the encoder 100 can be restored.

Hereinafter, the operation of the inverse update unit 240 and the inverse prediction unit 250 according to the second exemplary embodiment of the present invention will be described.

The inverse prediction unit 250 inversely predicts the re-estimation high-pass frame R′ by using the final low-pass frame L_{f}′ as a reference frame, thereby restoring the low-pass frame corresponding to the high-pass frame R′. To this end, the inverse prediction unit 250 performs the motion compensation with respect to peripheral low-pass frames by using the motion vector (MV) provided from the entropy decoding unit 210, thereby obtaining the prediction frame for the current low-pass frame. In addition, the inverse prediction unit 250 adds the re-estimation high-pass frame R′ to the prediction frame. Such an inverse prediction step is expressed in Equation 6.

The low-pass frame obtained by the inverse prediction unit 250 is sent to the inverse update unit 240. Upon receiving the low-pass frame, the inverse update unit 240 inversely updates the low-pass frame by using the high-pass frame R′ located in the temporal level identical to that of the low-pass frame. At this time, the motion compensation is performed with respect to the high-pass frame R′ by using a motion vector, which is obtained by changing the sign of the motion vector provided from the entropy coding unit 210. The inverse update unit 240 may repeat the inverse update step by using the low-pass frame provided from the inverse prediction unit 250.

If the input frame located in the temporal level 0 has been restored through the inverse update process, the inverse update unit 240 outputs the restored low-pass frame L₀′.

Meanwhile, the inverse update step and the inverse prediction step of the first exemplary embodiment may be performed inversely to those of the second exemplary embodiment. That is, according to the first exemplary embodiment of the present invention, the inverse prediction step is performed after the inverse update step. Therefore, the video decoding process according to the first exemplary embodiment of the present invention is substantially identical to the conventional inverse MCTF process, except that data for the inputted high-pass frame are related to the re-estimation high-pass frame.

According to the third exemplary embodiment of the present invention, the inverse update unit 240 further performs a step of determining whether the inputted low-pass frame is located in a position having the high-pass frames. If the inputted low-pass frame is located in the position having the high-pass frames, the inverse update step for the corresponding low-pass frame may be omitted. Otherwise, the inverse update step is performed with respect to the corresponding low-pass frame

FIG. 11 is a block view illustrating the structure of a system for realizing the operation of the video encoder 100 or the video decoder 200. The system may include a TV, a set-top box, a desktop computer, a laptop computer, palmtop computer, a PDA (personal digital assistant), a video or an image storage device (e.g., a VCR (video cassette recorder) or a DVR (digital video recorder)). In addition, the system may include a combination of the above devices or a device provided as a part of other equipment. The system has at least one video source 910, at least one input/output unit 920, a processor 940, a memory 950, and a display unit 930.

The video source 910 may include a TV receiver, a VCR or a video storage unit. In addition, the video source 910 may be at least one network connection for receiving a video signal from a server through the Internet, a WAN (wide area network), a LAN (local area network), a terrestrial broadcast system, a cable network, a satellite communication network, a wireless network or a telephone network. Furthermore, the video source 910 may include a combination of the above networks or a network provided as a part of other network.

The input/output unit 920, the processor 940 and the memory 950 are communicated with each other through a communication medium 960. The communication medium 960 includes a communication bus, a communication network, or at least one internal connection circuit. Video data inputted from the video source 910 can be processed by means of the processor 940 according to at least one software program stored in the memory 950, or can be executed by means of the processor 940 in order to generate an output video signal transmitted to the display unit 930.

In particular, the software program stored in the memory 950 may include a scalable video codec performing the method of exemplary embodiments of the present invention. The encoder or the scalable video codec may be stored in the memory 950 or a storage medium, such as a CD-ROM or a floppy disc. It is also possible to download the encoder or the scalable video codec from a predetermined server through various networks. In addition, the encoder or the scalable video codec can be replaced with a hardware circuit by means of the software program or can be replaced with a combination of software and hardware circuits.

As described above, according to exemplary embodiments of the present invention, the drift error between the encoder and the decoder can be effectively reduced without deteriorating advantages of the prediction and update steps of the conventional MCTF, so that the data-compression efficiency can be significantly improved.

Further, according to exemplary embodiments of the present invention, the closed-loop prediction step can be applied to fast moving images for which the conventional MCTF process could not be effectively implemented due to the large residual energy caused by the fast moving images, thereby improving the performance. In addition, the update step can be applied to the slow moving images without causing the mismatch, thereby improving the performance.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A video encoding method comprising:
dividing input frames into a final low-pass frame and at least one high-pass frame through a motion compensated temporal filtering;
coding the final low-pass frame and then decoding the coded final low-pass frame;
re-estimating the at least one high-pass frame by using the decoded final low-pass frame; and
coding the re-estimated high-pass frame.

2. The video encoding method as claimed in claim 1, wherein the re-estimating the high-pass frame comprises:
re-estimating a high-pass frame located in a temporal level identical to a predetermined temporal level of a first low-pass frame, which has been restored, by using the first low-pass frame as a reference frame;
coding the re-estimated high-pass frame and then decoding the coded re-estimated high-pass frame;
inversely predicting the decoded re-estimated high-pass frame by using the first low-pass frame as a reference frame, thereby restoring a second low-pass frame corresponding to the decoded high-pass frame; and
inversely updating the first low-pass frame by using the decoded high-pass frame.

3. The video encoding method as claimed in claim 1, further comprising obtaining bit streams from the coded final low-pass frame and the coded at least one high-pass frame.

4. The video encoding method as claimed in claim 1, wherein the dividing input frames comprises obtaining a high-pass frame for a current frame with reference to a frame located in a different temporal position, and updating the frame located in the different temporal position by using the obtained high-pass frame.

5. The video encoding method as claimed in claim 1, wherein the coding the final low-pass frame comprises:
obtaining a transform coefficient by transforming the low-pass frame;
quantizing the transform coefficient;
de-quantizing a quantized result of the quantizing; and
inversely transforming a de-quantized result of the de-quantizing.

6. The video encoding method as claimed in claim 2, wherein the inversely updating the first low-pass frame is performed only if the first low-pass frame is located in a temporal position in which the at least one high-pass frame obtained in the dividing of the input frames is not located.

7. A video decoding method comprising:
restoring a final low-pass frame and at least one high-pass frame from texture data included in an input stream; and
restoring low-pass frames located in a lowest time level from among the final low-pass frame and at least one high-pass frame,
wherein the restoring the low-pass frames comprises:
inversely predicting the at least one high-pass frame by using a first low-pass frame located in a predetermined temporal level as a reference frame, thereby restoring a second low-pass frame having the same temporal position as the at least one high-pass frame; and
inversely updating the first low-pass frame using the at least one high-pass frame.

8. The video decoding method as claimed in claim 7, wherein the restoring the final low-pass frame comprises:
losslessly decoding the input bit stream;
de-quantizing texture data from among results of the lossless decoding; and
inversely transforming a de-quantized result of the de-quantizing.

9. The video decoding method as claimed in claim 7, wherein the inversely updating the first low-pass frame is performed only if the first low-pass frame is located in a temporal position in which the high-pass frame is not located.

10. A video encoder comprising:
means for dividing input frames into one final low-pass frame and at least one high-pass frame through a motion compensated temporal filtering;
means for coding the final low-pass frame;
means for decoding the coded final low-pass frame;
means for re-estimating the at least one high-pass frame by using the decoded final low-pass frame; and
means for coding the re-estimated at least one high-pass frame.

11. The video encoder as claimed in claim 10, wherein the re-estimating means includes:
means for re-estimating a high-pass frame located in a temporal level identical to a predetermined temporal level of a first low-pass frame, which has been restored, by using the first low-pass frame as a reference frame;
means for coding the re-estimated high-pass frame and then decoding the coded re-estimated high-pass frame;
means of inversely predicting the decoded re-estimated high-pass frame by using the first low-pass frame as a reference frame, thereby restoring a second low-pass frame corresponding to the decoded high-pass frame; and
means for inversely updating the first low-pass frame by using the decoded high-pass frame.

12. The video encoder as claimed in claim 10, further comprising means for obtaining bit streams from the coded final low-pass frame and the coded at least one high-pass frame.

13. The video encoder as claimed in claim 10, wherein the dividing means for dividing the input frames comprises means for obtaining a high-pass frame for a current frame with reference to a frame located in a different temporal position, and means for updating the frame located in the different temporal position by using the obtained high-pass frame.

14. The video encoder as claimed in claim 10, wherein the means for decoding comprises:
means for obtaining a transform coefficient by transforming the low-pass frame;
means for quantizing the transform coefficient;
means for de-quantizing a quantized result of the means for quantizing;
means for inversely transforming a de-quantized result of the means for de-quantizing.

15. The video encoder as claimed in claim 11, wherein the means for inversely updating inversely updates the first low-pass frame only if the first low-pass frame is located in a temporal position in which the high-pass frame is not located.

16. A video decoder comprising:
first means for restoring a final low-pass frame and at least one high-pass frame from texture data included in an input stream; and
second means for restoring low-pass frames located in a lowest time level from among the final low-pass frame and at least one high-pass frame, wherein the second means for restoring includes:
means for inversely predicting the at least one high-pass frame by using a first low-pass frame located in a predetermined temporal level as a reference frame, thereby restoring a second low-pass frame having the same temporal position as the at least one high-pass frame; and
means for inversely updating the first low-pass frame using the at least one high-pass frame.

17. The video decoder as claimed in claim 16, wherein the first means for restoring includes:
means for losslessly decoding the input bit stream;
means for de-quantizing texture data from among results of the lossless decoding; and
means for inversely transforming the de-quantized result.

18. The video decoder method as claimed in claim 16, wherein the means for inversely updating inversely updates the first low-pass frame only if the first low-pass frame is located in a temporal position in which the high-pass frame is not located.

19. A recording medium to be read by means of a computer, the recording medium having a program code capable of executing a video encoding method, the method comprising:
dividing input frames into a final low-pass frame and at least one high-pass frame through a motion compensated temporal filtering;
coding the final low-pass frame and then decoding the coded final low-pass frame;
re-estimating the at least one high-pass frame by using the decoded final low-pass frame; and
coding the re-estimated at least one high-pass frame.

20. A recording medium to be read by means of a computer, the recording medium having a program code capable of executing a video decoding method, the method comprising:
restoring a final low-pass frame and at least one high-pass frame from texture data included in an input stream; and
restoring low-pass frames located in a lowest time level from among the final low-pass frame and at least one high-pass frame,
wherein the restoring the low-pass frames comprises:
inversely predicting the at least one high-pass frame by using a first low-pass frame located in a predetermined temporal level as a reference frame, thereby restoring a second low-pass frame having the same temporal position as the at least one high-pass frame; and
inversely updating the first low-pass frame using the at least one high-pass frame.
